(19) United States
(12) Patent Application Publication
(10) Pub. No.: US 2006/0091172 A1
(43) Pub. Date: May 4, 2006

(54) Cargo box for a vehicle

(76) Inventors: Del W. Gray, Hooper, UT (US); Richard K. Dixon, West Haven, UT (US)

Correspondence Address: Thompson E. Fehr;Goldenwest Corporate Center, Suite 300, 5025 Adams Avenue, Ogden, UT, 84403, US

(21) Appl. No.: 10/980,952

(22) Filed: Nov. 4, 2004

(51) Int. Cl. B60R 9/00

(52) U.S. Cl. 224/519; 224/527

(57) ABSTRACT

A cargo box for a vehicle having a support bar to which are attached a first side hollow tube and a second side hollow tube. On the bottom of a box are connected a first hollow tube and a second hollow tube. A first rod releasably connects the first side hollow tube and the first hollow tube while a second rod releasably connects the second side hollow tube and the second hollow tube. In a first option, a middle hollow tube accommodates a hitch so that a vehicle can be towed behind the vehicle, preferably a recreational vehicle, to which the support bar is attached. Another option, elevates the box.

### BACKGROUND OF THE INVENTION

1. Field of the Invention

This invention relates to a container for storing cargo on a vehicle, especially a recreational vehicle.

2. Description of the Related Art

Numerous patents have been granted for cargo containers for a vehicle.

In the Two-wheeled Vehicle Carrier of U.S. Pat. No. 3,176,903, two tubular members can be adjustably slid into two receivers. The only means disclosed for attaching tubular members the angle iron that will be nearer the automotive vehicle to hold the wheels of the two-wheeled vehicle is rigid affixing by “welding, or the like.”

The container of U.S. Pat. No. 5,033,662 is attached at a fixed, elevated position to two rails that slide into receivers.

Although employing only one rail, the carrier of U.S. Pat. No. 5,106,002 is also elevated above the position at which the rail enters the receiver.

The Utility Rack of U.S. Pat. No. 5,215,234 has a platform that is elevated by two L-shaped rails above the point at which such rails enter receivers that are secured to a mounting plate to be bolted to the frame of a vehicle.

U.S. Pat. No. 5,224,636 applies to a rack which is rigidly attached to arms which have several holes on an end intended to be placed into brackets or receivers on a vehicle so that the distance of the rack from the vehicle can be adjusted.

The box of U.S. Pat. No. 5,460,304 does not appear to be able to have its distance from the vehicle adjusted but does have an elevated support, that does appears—at least in the embodiment of FIG. 11—to be vertically adjustable, for the box.

A box in the design of U.S. Pat. No. 5,586,702 is screwed or bolted to a frame which has its distance from the vehicle adjusted in basically the same manned as does U.S. Pat. No. 5,224,636.

Moreover, the device of U.S. Pat. No. 5,881,937 employs the same structure as that discussed above for U.S. Pat. No. 5,586,702.

The platform of U.S. Pat. No. 5,996,869 utilizes a U-shaped bracket adjustably to connect such platform to a drawbar.

The platform for the box in U.S. Pat. No. 6,152,341 is elevated somewhat, although it does not appear to be vertically adjustable.

And the platform of U.S. Pat. No. 6,179,184 uses the same structure as that described for U.S. Pat. No. 5,996,869.

The cargo carrier of U.S. Pat. No. 6,293,451 is similar to that of U.S. Pat. No. 6,152,341.

U.S. Pat. No. 6,390,343 covers a device having a platform attached, “by welding, gluing, using fasteners, and the like,” with a uniquely designed connector and base member to an adapter which fits into a receiver on a vehicle and adjusts the distance between the platform and the vehicle in the same manner as do U.S. Pat. Nos. 5,224,636 and 5,586,702.

The cargo compartment of U.S. Pat. No. 6,398,290 is apparently attached at a fixed point to a tubular member 1870 that, in the preferred embodiment, slides into a section 1870 and can be retained (with a pin) only at the point at which the cargo compartment is closest to the vehicle to which the overall unit is attached.

The mount of U.S. Pat. No. 6,511,088 is apparently vertically, but not horizontally, adjustable.

The device of U.S. Pat. No. 6,662,983 has a folding platform that is placed atop an L-shape member with the other end of the L-shaped member being inserted into a receiver on a vehicle and utilized to adjust the distance between the platform and the vehicle in the same manner as do U.S. Pat. Nos. 5,224,636; 5,586,702; and 6,390,343; the height of the platform also appears to be adjustable. Such horizontal and vertical adjustment appears also to be much the same as that for the Utility Holder of U.S. Pat. No. 5,752,639.

In the carrier rack of United States patent application publication no. US 2001/0030216 the rack has three mounting bars which fit into three receivers. The central receiver extends perpendicularly to a hollow tube that is to be attached to a towing vehicle. The two outside receivers each has a stem projecting perpendicularly to the receivers; each stem is slid into one of the open ends of the hollow tube.

For the cargo carrier of United States patent no. US 2002/0005423, a hitch receiver bar runs perpendicular to three receivers which are mounted perpendicularly to the bar. The receivers may each be either a “sleeve . . . or a boss.”

The cargo carrier of United States patent application publication no. US 2003/0155390 has smaller tubes of a connection frame which slide into larger tubes of a carrier frame, but the tubes only lock in a position with the carrier frame near the vehicle.

For United States patent application publication no. US 2004/0011837, two tubes project outwardly from the sides of a receiver box. Each tube has attached to it an upwardly oriented circular accessory receiver.

And U.S. Pat. Nos. 4,938,399; 5,699,985; and 5,853,278 as well as United States patent application publication nos. US 2001/0030216 and US 2003/0173387 all have some form of hitch oriented toward the rear of the carrier so that another device may be connected behind such carrier.

None of the preceding patents or applications, however, possess a hollow tubes or receivers on the bottom of the cargo box for receiving tubes that also fit into hollow tubes or receivers attached to a support bar that is bolted, welded, or otherwise fixedly attached to a vehicle. Nor do such patents or applications seem to have tube that are adjustable at either end, i.e., the end fitting into a receiver attached to the vehicle and the end near the cargo box.

### BRIEF SUMMARY OF THE INVENTION

The present Cargo Box for a Vehicle comprises a support bar for fixed connection, preferably by bolting or welding, to a vehicle, preferably a recreational vehicle. Attached to the support bar are two side hollow tubes or receivers and a middle hollow tube or receiver.

Connected to the bottom of a box are two hollow tubes or receivers. A first rod connects a first side hollow tube to a first hollow tube on the bottom of the box. Similarly, a second rod connects a second side hollow tube to a first hollow tube on the bottom of the box. At least one end of each rod, and preferably both ends, can be locked at different selected positions in the side hollow tube or the tube on the bottom of the box.

Optionally, a middle hollow tube is employed. Either a first end of any type of hitch known in the art may be inserted into the middle hollow tube or a first end of a third rod is inserted into the tube. The second end of the third rod is connected to any type of hitch that is known in the art, preferably a hollow tube with apertures in each side.

Preferably, each hollow tube, each side hollow tube, each rod, and the middle hollow tube have a square cross section.

Optionally, the second end of each side hollow tube is oriented substantially vertically; and a first end of an auxiliary rod for association with each side hollow tube has a vertical channel which can be placed around the second end of a side hollow tube selectively locked along the substantially vertical second end of the side hollow tube. With such an option, the second ends of the auxiliary rods are placed into the tubes on the bottom of the box.

### BRIEF DESCRIPTION OF THE SEVERAL VIEWS OF THE DRAWING

FIG. 1 portrays the basic Cargo Box for a Vehicle.

FIG. 2 shows the optional third rod.

FIG. 3 depicts the optional substantially vertical second end of a rod.

### DETAILED DESCRIPTION OF THE INVENTION

The present invention is a cargo box 1 which can be mounted at varying distances from the rear of a vehicle, especially a motor home, trailer, or other recreational vehicle.

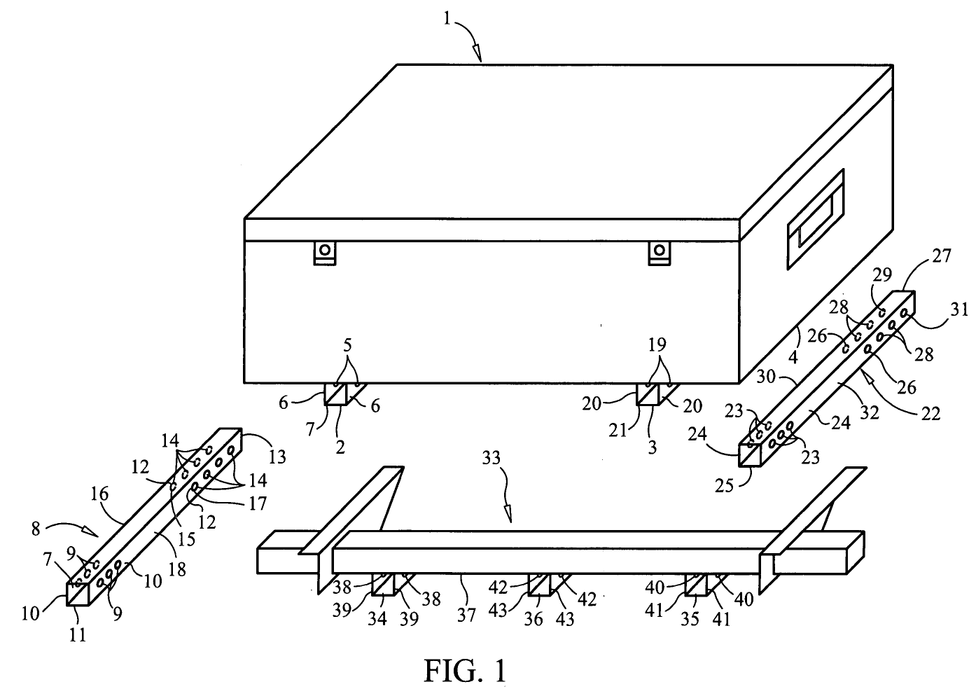

As seen in FIG. 1, two hollow tubes 2, 3 are attached to the bottom 4 of the box 1. The first tube 2 has an aperture 5 in each side 6 of the first tube 2 near the rear 7 of the first tube 2 with such apertures 5 being aligned with one another. Also, the first tube 2 has dimensions selected to allow the first tube 2 to accommodate a first rod 8 which has one or more apertures 9 in each side 10 of the first rod 8 near the rear 11 of the first rod 8, with such apertures 9 being aligned with one another, and also two or more apertures 12 in each side 10 of the first rod 8 commencing near the front 13 of the first rod 8, with the apertures 9, 12 being organized into pairs 14 having a first member 15 of each pair 14 located on a first side 16 of the first rod 8 and aligned with the second member 17 of the pair 14, which second member 17 is located on a second side 18 of the first rod 8. Similarly, the second tube 3 has an aperture 19 in each side 20 of the second tube 3 near the rear 21 of the second tube 3 with such apertures 19 being aligned with one another; and the second tube 3 has dimensions selected to allow the second tube 3 to accommodate a second rod 22 which has one or more apertures 23 in each side 24 of the second rod 22 near the rear 25 of the second rod 22, with such apertures 23 being aligned with one another, and also two or more apertures 26 in each side 24 of the second rod 22 commencing near the front 27 of the second rod 22, with the apertures 23, 26 being organized into pairs 28 having a first member 29 of each pair 28 located on a first side 30 of the second rod 22 and aligned with the second member 31 of the pair 28, which second member 31 is located on a second side 32 of the second rod 22.

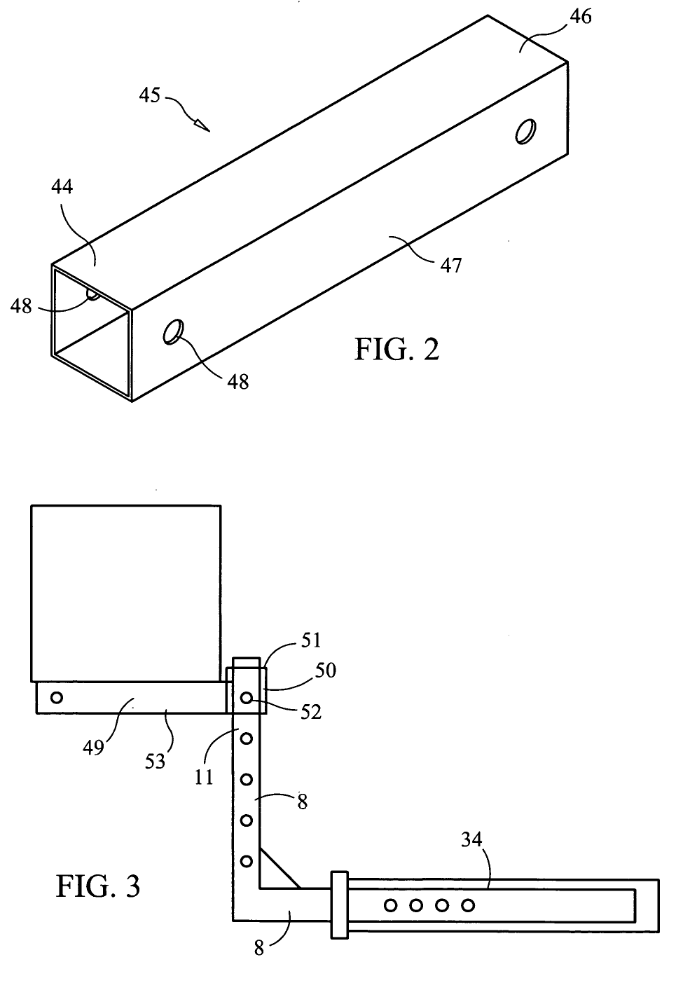

A support bar 33 is available for connection (preferably, by bolting or welding) to the rear of the recreational vehicle. A first side hollow tube 34; a second side hollow tube 35, and, preferably, a middle hollow tube 36; are attached to the support bar 33, preferably to the bottom 37 of such support bar 33. The first side hollow tube 34 contains an aperture 38 in each side 39 of the first side tube 34 with such apertures 38 being aligned with one another, and the second side hollow tube 35 has an aperture 40 in each side 41 of the second side tube 35 with such apertures 40 being aligned with one another. And, when the middle hollow tube 36 is employed, the middle hollow tube 36 possesses an aperture 42 in each side 43 of the middle hollow tube 36 with such apertures 42 being aligned with one another. The first side tube 34 has dimensions selected to allow the first side tube 34 to accommodate the first rod 8, and the second side tube 35 has dimensions selected to allow the second side tube 35 to accommodate the second rod 22. The middle hollow tube 36 is selected to have dimensions to accommodate either a hitch that is well known in the art or a front end 44 of a third rod 45 having its rear end 46 releasably connectable to any type of hitch that is known in the art, preferably, as illustrated in FIG. 2, a hollow shaft 47 having aligned paired apertures 48 so that a pin can be inserted through apertures 42, 43, and 48 to retain the hollow shaft 47 within the middle tube 36. (Preferably, when a hitch is accommodated by the middle hollow tube 36, such hitch also has apertures to facilitate retention by the middle hollow tube 36.) Thus, a trailer can be pulled behind the vehicle even when the cargo box 1 is in place.

In operation, a rear end 11 of the first rod 8 is inserted into the first tube 2 such that the apertures 5 are aligned with the apertures 9. Then a receiver pin is placed through the aligned apertures 5, 9 for the first tube 2 and for the first rod 8. Additionally, a front end 13 of the first rod 8 is inserted into the first side hollow tube 34 such that a selected pair 14 of the apertures 12 is aligned with the apertures 38 in the first side hollow tube 34. Similarly, a rear end 25 of the second rod 22 is inserted into the second tube 3 such that the apertures 19 are aligned with the apertures 23. Then a receiver pin is placed through the aligned apertures 19, 23 for the second tube 3 and for the second rod 22. Additionally, a front end 27 of the second rod 22 is inserted into the second side hollow tube 35 such that a selected pair 28 of the apertures 26 is aligned with the apertures 40 in the second side tube 35. The selection of the pairs 14, 28 naturally determines the distance that the box 1 is located from the recreational vehicle. Preferably, of course, a user will select such pairs 14, 28 that the first rod 8 and the second rod 22 will be parallel to one another. (One of ordinary skill in the art will certainly recognized that multiple pairs of apertures could exist in the tubes 2, 3 and side hollow tubes 34, 35 with only a single pair of apertures in each end of the rods 8, 22 and that, rather than having a pair of apertures, the rods 8, 22 could be solid with a channel in lieu of two paired apertures.)

Optionally, as illustrated in FIG. 3, each rod 8, 22 is bent so that the rear end 11, 25 of each rod 8, 22 is oriented substantially vertically. A first extension rod 49 is constructed the same as the rear end 11 of the unbent first rod 8, as described above, except that the front end 50 contains a channel (or apertures) 51 so that such front end 50 can slide along the substantially vertical rear end 11 of the first rod 8. Paired, aligned apertures 52 exist in the sides 53, 54 of the first extension rod 49 intersecting the channel 51 so that a pin can be inserted through apertures 52 and into apertures 9 of the first rod 8 in order to lock the first extension rod 49 at a vertical location. Similarly, a second extension rod 55 is constructed the same as the rear end 25 of the unbent second rod 22, as described above, except that the front end 56 contains a channel (or apertures) 57 so that such front end 56 can slide along the substantially vertical rear end 25 of the second rod 22. Paired, aligned apertures 58 exist in the sides 59, 60 of the second extension rod 55 intersecting the channel 57 so that a pin can be inserted through apertures 58 and into apertures 23 of the second rod 22 in order releasably to lock the second extension rod 55 at a vertical location.

Preferably, each hollow tube 2, 3; each side hollow tube 34, 35, 45; each rod 8, 22; the middle hollow tube 36; and each extension rod 49, 55 has a square cross section.

As used herein, the term “substantially” indicates that one skilled in the art would consider the value modified by such terms to be within acceptable limits for the stated value. Also as used herein the term “preferable” or “preferably” means that a specified element or technique is more acceptable than another but not that such specified element or technique is a necessity.

We claim:

1. A cargo box for a vehicle, which comprises:
a support bar;
a first side hollow tube connected to said support bar;
a second side hollow tube connected to said support bar;
a first rod having a front end and a rear end and also having dimensions selected such that said first side hollow tube can accommodate said first rod;
a means for releasably retaining the front end of said first rod in said first side hollow tube;
a second rod having a front end and a rear end and also having dimensions selected such that said second side hollow tube can accommodate said second rod;
a means for releasably retaining the front end of said second rod in said second side hollow tube;
a box having a bottom;
a first hollow tube attached to the bottom of said box, said first hollow tube having dimensions selected such that said first hollow tube can accommodate said first rod;
a means for releasably retaining the rear end of said first rod in said first hollow tube, wherein at least one of said means for releasably retaining the front end of said first rod in said first side hollow tube and said means for releasably retaining the rear end of said first rod in said first hollow tube can adjustably select a position along said first rod at which said first rod is retained;
a second hollow tube attached to the bottom of said box, said second hollow tube having dimensions selected such that said second hollow tube can accommodate said second rod; and
a means for releasably retaining the rear end of said second rod in said second hollow tube, wherein at least one of said means for releasably retaining the front end of said second rod in said second side hollow tube and said means for releasably retaining the rear end of said second rod in said second hollow tube can adjustably select a position along said second rod at which said second rod is retained.

2. The cargo box for a vehicle as recited in claim 1, further comprising:
a middle hollow tube connected to said support bar, said middle hollow tube having dimensions to accommodate a hitch; and
a means for releasably retaining a hitch within said middle hollow tube.

3. The cargo box for a vehicle as recited in claim 1, further comprising:
a middle hollow tube connected to said support bar;
a third rod having a front end with dimensions such that said third rod can be accommodated in said middle hollow tube, said third rod having a rear end releasably connectable to a hitch; and
a means for releasably retaining said third rod within said middle hollow tube.

4. A cargo box for a vehicle, which comprises:
a support bar;
a first side hollow tube connected to said support bar;
a second side hollow tube connected to said support bar;
a first rod having a front end and a rear end and also having dimensions selected such that said first side hollow tube can accommodate said first rod, said first rod being bent so that the rear end of said first rod is substantially vertical;
a means for releasably retaining the front end of said first rod in said first side hollow tube;
a second rod having a front end and a rear end and also having dimensions selected such that said second side hollow tube can accommodate said second rod, said second rod being bent so that the rear end of said second rod is substantially vertical;
a means for releasably retaining the front end of said second rod in said second side hollow tube;
a first extension rod having a front end containing a channel so that such front end can slide along the substantially vertical rear end of said first rod, said first extension rod also having a rear end;
a means for releasably retaining said first extension rod at a desired vertical location along the substantially vertical rear end of said first rod;
a second extension rod having a front end containing a channel so that such front end can slide along the substantially vertical rear end of said second rod, said second extension rod also having a rear end;
a means for releasably retaining said second extension rod at a desired vertical location along the substantially vertical rear end of said second rod;
a box having a bottom;
a first hollow tube attached to the bottom of said box, said first hollow tube having dimensions selected such that said first hollow tube can accommodate said first rod;
a means for releasably retaining the rear end of said first extension rod in said first hollow tube, wherein at least one of said means for releasably retaining the front end of said first rod in said first side hollow tube and said means for releasably retaining the rear end of said first extension rod in said first hollow tube can adjustably select a position for retention;
a second hollow tube attached to the bottom of said box, said second hollow tube having dimensions selected such that said second hollow tube can accommodate said second rod; and
a means for releasably retaining the rear end of said second extension rod in said second hollow tube, wherein at least one of said means for releasably retaining the front end of said second rod in said second side hollow tube and said means for releasably retaining the rear end of said second extension rod in said second hollow tube can adjustably select a position for retention.

5. The cargo box for a vehicle as recited in claim 4, further comprising:
a middle hollow tube connected to said support bar, said middle hollow tube having dimensions to accommodate a hitch; and
a means for releasably retaining a hitch within said middle hollow tube.

6. The cargo box for a vehicle as recited in claim 4, further comprising:
a middle hollow tube connected to said support bar;
a third rod having a front end with dimensions such that said third rod can be accommodated in said middle hollow tube, said third rod having a rear end releasably connectable to a hitch; and
a means for releasably retaining said third rod within said middle hollow tube.
